(19) United States
(12) Patent Application Publication
(10) Pub. No.: US 2025/0102077 A1
(43) Pub. Date: Mar. 27, 2025

(54) UNMANNED AERIAL VEHICLE SYSTEMS AND METHODS FOR HEAP LEACH PAD IRRIGATION LINE PLACEMENT

(71) Applicant: FREEPORT MINERALS CORPORATION, Phoenix, AZ (US)

(72) Inventors: Hector Romo, Morenci, AZ (US); Steven Richardson, Thatcher, AZ (US); Jason Green, Safford, AZ (US)

(73) Assignee: FREEPORT MINERALS CORPORATION, Phoenix, AZ (US)

(21) Appl. No.: 18/891,407

(22) Filed: Sep. 20, 2024

Related U.S. Application Data
(60) Provisional application No. 63/671,960, filed on Jul. 16, 2024.
(60) Provisional application No. 63/584,730, filed on Sep. 22, 2023.

(51) Int. Cl. F16L 1/024; B64U 10/16; B64U 30/24; B64U 101/40; G05D 1/656; G05D 105/05; G05D 109/25

(52) U.S. Cl. CPC F16L 1/0243; B64U 10/16; B64U 30/24; G05D 1/665; B64U 2101/40; G05D 2105/05; G05D 2109/254

(57) ABSTRACT

An Unmanned Aerial Vehicle (“UAV”) system includes a UAV configured for lifting, positioning, and placing irrigation lines on a heap including side slopes. The UAV can be equipped with an irrigation line support structure configured for supporting, transporting and/or releasing one or more irrigation lines. Placement of the irrigation lines via the UAV system can enable accurate distribution of raffinate solutions to enhance leaching efficiency in areas which are typically difficult to access.

### CROSS-REFERENCE TO RELATED APPLICATIONS

This application claims priority to and the benefit of U.S. Provisional Patent Application Ser. No. 63/584,730, filed Sep. 22, 2023, entitled “Unmanned Aerial Vehicle Systems and Methods for Heap Leach Pad Irrigation Line Placement,” and U.S. Provisional Patent Application Ser. No. 63/671,960, filed Jul. 16, 2024, entitled “Unmanned Aerial Vehicle Systems and Methods for Heap Leach Pad Irrigation Line Placement,” the disclosures of which are incorporated herein by reference in their entireties for all purposes.

### FIELD

The present disclosure generally relates to systems, devices, and methods for placing irrigation lines on a heap to form an irrigation system for a heap leach pad, and more specifically to lifting, positioning, and placing irrigation lines on heap via aerial systems, devices, and methods.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

Copper heap leaching processes require uniform distribution of raffinate solutions across a surface of heap leach pads, which can be hindered by inaccessible areas such as side slopes. Conventional methods for irrigation line placement involve labor-intensive processes or heavy wheeled or tracked mobile lifting and installation tractors, back hoes, and similar machinery, which are time-consuming and costly and have limited ability to operate effectively and safely on steep slopes and similarly uneven, inaccessible areas of the heap leach pad. Accordingly, improved systems and methods for lifting, positioning, and placing irrigation lines on a heap leach pad may be desirable.

### SUMMARY

Disclosed herein is a method for installing irrigation lines on a heap of a heap leach pad, and one or more unmanned aerial vehicles (“UAVs”) UAVs configured for performing the method, and a UAV system configured for performing the method. Although described further herein as a method for installing irrigation lines on a heap leach pad, the present disclosure is not limited in this regard. For example, the UAV system and corresponding methods disclose herein can be utilized in various other similar applications, such as agricultural instillation of irrigation, placement of erosion blankets (e.g., that can be tethered to a handling assembly that is coupled to a UAV), various reclamation applications, stabilizing slopes of a heap leach pad with erosion nets, a transient revegetation application, or any other applications that may be readily apparent to one skilled in the art.

In various embodiments, the method comprises lifting, via one or more UAVs, an irrigation line; transporting, via the one or more UAVs, the irrigation line to the heap; and positioning, via the one or more UAVs, the irrigation line on the heap.

In various embodiments, the transporting the irrigation line includes transporting a first end of the irrigation line from a staging area to a top surface of the heap. The positioning the irrigation line can include releasing the first end of the irrigation line from the one or more UAVs onto the top surface of the heap. In various embodiments, the top surface of the heap may be sloped. The method can further comprise coupling the first end of the irrigation line to an irrigation system. The method can further comprise decoupling a second end of the irrigation line from an apparatus on a ground surface, and coupling the second end to the irrigation system, wherein the irrigation line is oriented along a sloped surface of the heap and extending from the first end to the second end along the sloped surface of the heap.

In various embodiments, the method further comprises unwinding the irrigation line from a spool during the transporting the irrigation line. The spool can be disposed on a ground surface proximate the heap.

In various embodiments, a first end of the irrigation line is supported by a harness during the transporting the irrigation line. The positioning the irrigation line can further comprise releasing the harness onto a top surface of the heap. The method can further comprise decoupling the first end of the irrigation line from the harness after the releasing the harness onto the top surface of the heap, and coupling the first end of the irrigation line to an irrigation system. The lifting of the irrigation line can further comprise lifting a plurality of irrigation lines via the harness, and the method can further comprise decoupling the first end of each of the plurality of irrigation lines from the harness after the releasing the harness onto the top surface, and coupling the first end of each of the plurality of irrigation lines to the irrigation system.

In various embodiments, the lifting of the irrigation line further comprises lifting a plurality of irrigation lines via a harness, the plurality of irrigation lines including the irrigation line. In various embodiments, the method further comprises releasing a first end of each of the plurality of irrigation lines from the harness sequentially. In various embodiments, the method further comprises releasing a first end of each of the plurality of irrigation lines from the harness simultaneously.

In various embodiments, the method further comprises releasing a first end of the irrigation line from one of the one or more UAVs; decoupling a second end of the irrigation line from one of a second of the one or more UAVs or an apparatus disposed on a ground surface; coupling the first end of the irrigation line to an irrigation system of the heap leach pad; and coupling the second end of the irrigation line to the irrigation system of the heap leach pad. Responsive to the coupling the first end and the second end of the irrigation line to the irrigation system, the irrigation line extends from a top surface of the heap leach pad, down a sloped surface of the heap leach pad, to one of the ground surface or an intermediate level down the slope.

In various embodiments, the positioning of the irrigation line includes adjusting, via the one or more UAVs, a position of the irrigation line on the heap based on sensor data received from one or more sensors of the one or more UAVs.

In various embodiments, the positioning further comprises unwinding, via the one or more UAVs, the irrigation line on the heap.

A UAV configured for precise placement of irrigation lines on a heap is disclosed herein. In various embodiments, the UAV comprises a UAV body; a propulsion system coupled to the UAV body; an irrigation line support structure coupled to the UAV body, the irrigation line support structure configured to couple one or more irrigation lines to the UAV body; a placement mechanism configured to release one of the irrigation line support structure or the one or more irrigation lines; and one or more controllers in operable communication with the propulsion system and the placement mechanism, the one or more controllers configured to: transport, via the propulsion system, the one or more irrigation lines to the heap; and place, via the positioning and navigation system, the one or more irrigation lines on the heap; and release, via the placement mechanism, one of the irrigation line support structure or the one or more irrigation lines on the heap.

In various embodiments, the irrigation line support structure comprises a harness, and the harness comprises one or more flanges, each of the one or more flanges configured to couple one of the one or more irrigation lines to the UAV body. In various embodiments, the irrigation line support structure comprises a handling assembly that includes a motorized winch and a placing device configured to securely grasp and release one of the one or more irrigation lines, the one or more controllers is further configured to adjust winding and unwinding speeds of the motorized winch, and optionally the motorized winch is capable of winding and unwinding the one of the one or more irrigation lines, and the handling assembly further comprises a gripping mechanism for secure line holding, and one or more sensors configured for alignment of each of the one or more irrigation lines during the placing of the one or more irrigation lines.

In various embodiments, the UAV further comprises a positioning and navigation system coupled to the UAV body, wherein: the one or more controllers are electronically coupled to the positioning and navigation system, and the positioning and navigation system includes a global positioning system (GPS), a light detection and ranging (“LiDAR”) system, and one or more sensors. In various embodiments, the one or more controllers is configured to monitor, based on data received from the one or more sensors, alignment and tension of one of the one or more irrigation lines during the placing of the one or more irrigation lines.

In various embodiments, the one or more controllers is further configured to: identify and locate, based on the global positioning system (GPS), a placement location for each of the one or more irrigation lines; and avoid, based on data received from LiDAR system and the one or more sensors, obstacles while placing the one or more irrigation lines. In various embodiments, the irrigation line support structure further comprises: a harness comprising a truss structure and one or more flanges extending from a beam of the truss structure; and a mount that couples the harness to the UAV body, the mount including one or more pivot arms to allow the harness to pivot relative to the UAV body during transporting of the one or more irrigation lines.

An unmanned aircraft system (“UAS”) comprising a UAV in accordance with various embodiments of the present disclosure, is disclosed herein. In various embodiments, the UAS comprises a remote-control interface configured to enable real-time adjustments, position monitoring, and supervision of the placing of each of the one or more irrigation lines. In various embodiments, the remote-control interface includes a transmitter, the UAV comprises a receiver, and the remote-control interface is configured to communicate with the one or more controllers of the UAV wirelessly through the receiver.

In various embodiments, the one or more controllers is further configured to position each of the one or more irrigation lines based on regional survey data and benchmark coordinates associated with the heap. In various embodiments, the one or more controllers is further configured to secure, via the placement mechanism, one of the one or more irrigation lines to the UAV. In various embodiments, the irrigation line support structure comprises a harness. In various embodiments, the harness comprises one or more attachment mechanisms, each of the one or more attachment mechanisms configured to couple one of the one or more irrigation lines to the harness.

An aerial system for installation of irrigation lines, is disclosed herein. in various embodiments, the aerial system comprises a plurality of UAVs including the UAV of claim 20, wherein the plurality of UAVs are configured to operate together to lift, position, and place each of the one or more irrigation lines on the heap.

An article of manufacture is disclosed herein. In various embodiments, the article of manufacture includes a tangible, non-transitory memory configured to communicate with one or more processors, the tangible, non-transitory memory having instructions stored thereon that, in response to execution by the one or more processors, cause the one or more processors to perform operations comprising: transport, by the one or more processors and through a propulsion system, an irrigation line to a heap; place, by the one or more processors and through the positioning and navigation system, the irrigation line on the heap; and release, by the one or more processors and through a placement mechanism, the irrigation line on the heap.

In various embodiments, the operations further comprise identify and locate, by the one or more processors and based on a global positioning system (GPS), a placement location for the irrigation line prior to the release of the irrigation line on the heap. In various embodiments, the operations further comprise avoiding, by the one or more processors and based on data received from a light detection and ranging (“LiDAR”) system and one or more sensors, obstacles while placing the irrigation line. In various embodiments, the operations further comprise: receiving, by the one or more processors and through a receiver, a command signal; and controlling, by the one or more processors, one of the placement mechanism or the propulsion system based on the command signal.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a perspective view of a heap leach pad, in accordance with various embodiments.

FIG. 2 illustrates a method of installing an irrigation line on a heap, in accordance with various embodiments.

FIG. 3A illustrates an illustrative view of a step from the method of FIG. 2, in accordance with various embodiments.

FIG. 3B illustrates an illustrative view of a step from the method of FIG. 2, in accordance with various embodiments.

FIG. 3C illustrates an illustrative view of a step from the method of FIG. 2, in accordance with various embodiments.

FIG. 4A illustrates an illustrative view of a step from the method of FIG. 2, in accordance with various embodiments.

FIG. 4B illustrates an illustrative view of a step from the method of FIG. 2, in accordance with various embodiments.

FIG. 5A illustrates an illustrative view of a step from the method of FIG. 2, in accordance with various embodiments.

FIG. 5B illustrates an illustrative view of a step from the method of FIG. 2, in accordance with various embodiments.

FIG. 6 illustrates an exploded view of a UAV adaptable to perform the method of FIG. 2, in accordance with various embodiments.

FIG. 7 illustrates a schematic view of a control system of a UAV adaptable to perform the method of FIG. 2, in accordance with various embodiments.

FIG. 8 illustrates a method utilizing the control system of FIG. 7, in accordance with various embodiments.

FIG. 9 illustrates a front view of a UAV adaptable to perform the method of FIG. 2, in accordance with various embodiments.

FIG. 10 illustrates a schematic view of a control system of a UAV adaptable to perform the method of FIG. 2, in accordance with various embodiments.

FIG. 11 illustrates a process performed by the control system of FIG. 10, in accordance with various embodiments.

### DETAILED DESCRIPTION

The following detailed description of various embodiments herein refers to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Disclosed herein is a UAV system configured to lift and place a plurality of irrigation lines on a heap leach pad (e.g., a copper heap leach pad, a nickel heap leach pad, a uranium heap leach pad, or the like). The UAV system can include a fleet of specialized UAVs designed and configured for the lifting, positioning, and placement of irrigation lines in difficult to access areas of a heap leach pad.

Although described herein as having a UAV system that is configured to lift and place a plurality of irrigation lines on a heap leach pad, the present disclosure is not limited in this regard. For example, the UAV system and corresponding methods disclose herein can be utilized in various other similar applications, such as agricultural instillation of irrigation, placement of erosion blankets (e.g., that can be tethered to a handling assembly that is coupled to a UAV), various reclamation applications, stabilizing slopes of a heap leach pad with erosion nets, a transient revegetation application, or any other applications that may be readily apparent to one skilled in the art.

A “UAV” as referred to herein can include a fully autonomous UAV, a remotely piloted UAV, or any other UAV that may be readily apparent to one skilled in the art. The present disclosure is not limited in this regard. Although described herein as utilizing one or more UAVs, the present disclosure is not limited in this regard. For example, a helicopter could be utilized instead of the one or more UAVs disclosed herein and would still be within the scope of this disclosure.

In various embodiments, each of the aerial UAVs in the fleet of specialized aerial UAVs can be equipped with a handling assembly (e.g., an irrigation line handling assembly). In various embodiments, the handling assembly comprises a release mechanism. In this regard, responsive to receiving a control input, the release mechanism can be configured to place one or more irrigation lines on a heap leach pad as described further herein. In various embodiments, the release mechanism can be biased in a closed position and transition to an open state in response to receiving a control input. However, the present disclosure is not limited in this regard and any release mechanism known in the art is within the scope of this disclosure.

In various embodiments, the handling assembly for each of the aerial UAVs in the fleet of specialized aerial UAVs can be equipped with an irrigation line support structure (e.g., a harness, a truss structure, or any other support structure known for carrying a payload that may be readily apparent to one skilled in the art). In this regard, the irrigation line support structure can be coupled to the respective UAV (e.g., via the release mechanism or fixedly coupled to the UAV). In response to being coupled to the UAV via the release mechanism, the irrigation line support structure and respective irrigation lines can be released together, in accordance with various embodiments. However, the present disclosure is not limited in this regard. For example, the irrigation line support structure 620 can include the release mechanism of the handling assembly as a component coupled thereto. In this regard, the release mechanism can be configured to release a single irrigation line, two or more irrigation lines simultaneously, two or more irrigation lines sequentially, or any other combination of releasing, in accordance with various embodiments.

Although described herein as including a release mechanism as an element of the handling assembly for each of the aerial UAVs in the fleet of specialize aerial UAVs, the present disclosure is not limited in this regard. For example, the handling assembly can comprise a motorized winch and a gripping mechanism. In this regard, the handling assembly can be capable of winding and unwinding irrigation lines, and the gripping mechanism can be configured to provide adjustable tension to securely grasp and release irrigation lines, as described further herein. Although described herein as including a motorized winch, the present disclosure is not limited in this regard. For example, the handling assembly can be configured to securely grasp an irrigation line and unwind the irrigation line from a spool or the like and still be within the scope of this disclosure.

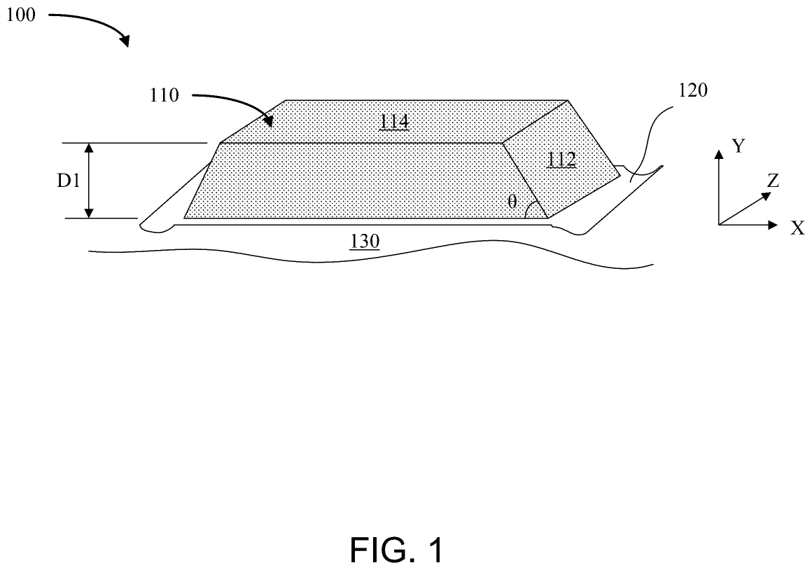

Referring now to FIG. 1, a perspective view of a heap leach pad 100 prior to placement of irrigation lines is illustrated, in accordance with various embodiments. The heap leach pad 100 comprises a large, engineered structure (i.e., a heap 110), lined with a lined pad 120 (e.g., an impermeable layer of polymeric material, such as a geosynthetic membrane) and placed over a prepared surface 130 (e.g., a compacted soil layer). Ore (e.g., copper ore, nickel ore, uranium ore, or any other ore known in the art), is placed on the lined pad to form the heap 110. As described further herein, the heap 110 is treated with chemicals to dissolve (i.e., leach) a metal of interest (e.g., copper, nickel, uranium, or any other metal of interest). The lined pad 120 placed at the bottom and around sides of the heap 110 prevents chemicals from leaking into the compacted soil of the prepared surface 130 and contaminating groundwater.

In order to treat the heap 110 with chemicals, an irrigation system is installed on the heap leach pad 100. The irrigation system is configured to drip a leach solution (e.g., a raffinate solution, a water solution with dilute sodium cyanide or sulfuric acid, or any other leach solution that may be readily apparent to one skilled in the art) onto the heap 110. In various embodiments, the irrigation system is configured to drip the leach solution on a top surface 114 of the heap 110. In order to generate a greater recovery of a respective metal (e.g., copper, nickel, uranium, or the like), it may be desirable to place irrigation lines along the sloped surface 112 of the heap 110.

The sloped surface 112 is sloped relative to a ground plane (i.e., the X-Z plane). A slope of the sloped surface 112 can be relatively steep. For example, the sloped surface 112 can be defined by a plane that forms an angle θ with the X-Z plane that is between 30° and 90°, or between 45° and 90°, or between 60° and 90°, or between 75° and 89°, or between 75° and 85°. Accordingly, in various embodiments, the sloped surface 112 can be difficult to access for personnel and/or equipment.

For installing and removing irrigation lines for heap leach pads in accordance with the heap leach pad 100 in FIG. 1, coordination and planning can be significant. For example, to install driplines for irrigation systems along the sloped surface 112 of the heap 110, a significant amount of labor and machinery is utilized. A team of irrigation assemblers (e.g., approximately eight people) and large construction equipment (e.g., a telehandler lift, a crane, forklifts, or the like) can be used to install irrigation lines along sloped surface 112 of the heap. In various embodiments, the equipment may be limited to a heap depth of approximately 600 feet (183 meters).

For installation on flat ground (e.g., the top surface 114 of the heap 110), a team can also be utilized in combination with large construction equipment to install the irrigation lines. For example, an all-terrain vehicle (“ATV”) can be used in combination with a crane to install irrigation lines laterally (i.e., in the X-direction) along the top surface 114 of the heap.

Similarly, for removing the irrigation lines, significant coordination and planning may be involved. For example, large construction equipment may be deployed, such as two distinct types of forklifts (i.e., one at a top of the sloped surface 112 and one at a bottom of the sloped surface 112, two forklifts at the top of the sloped surface 112), along with retractable devices.

Stated another way, installation and removal of irrigation lines for a heap leach pad 100 can typically include a full day of labor with eight or more people and significant construction equipment. However, as described further herein, systems and methods for irrigation line installation and removal on a heap leach pad 100 from FIG. 1 can include one or more aerial UAVs (e.g., a single aerial UAV or a fleet of aerial UAVs). In this regard, labor can be significantly reduced (e.g., to approximately one or two people), an amount of time for installation can be significantly reduced, and/or a cost of installation/removal can be reduced, in accordance with various embodiments. Additionally, in accordance with various embodiments, the systems and methods disclosed herein can facilitate (or enable) installation of irrigation drip lines on sloped surface 112 of a heap 110 with a depth of up to 1,500 feet (457 meters), or between 1,000 feet (305 meters) and 1,500 feet (457 meters). Although described herein as enabling a depth of greater than 1,000 feet (305 meters), the present disclosure is not limited in this regard. In particular, any depth of a heap 110 that is less than 1,000 feet (305 meters) is also within the scope of this disclosure. Accordingly, a heap 110 that is significantly larger relative to typical heaps can be treated via an irrigation system installed in accordance with the systems and methods disclosed herein, resulting in a significantly greater metal recovery for heap leaching, in accordance with various embodiments.

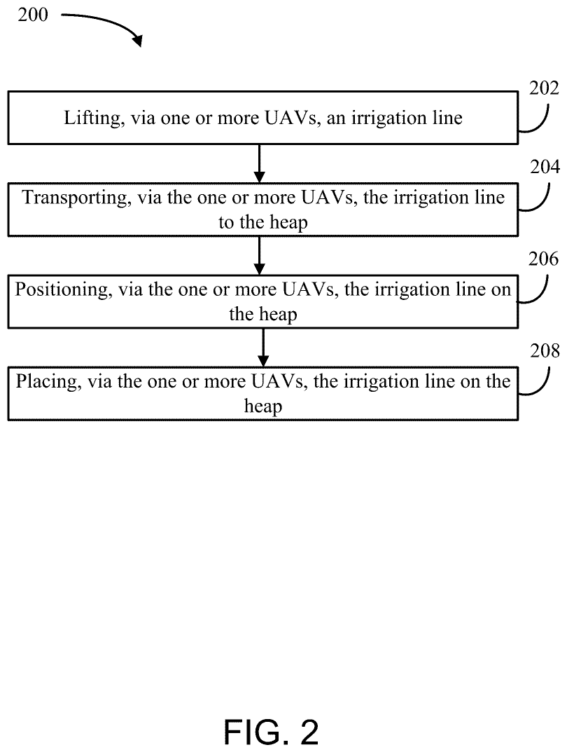

Referring now to FIG. 2, a method 200 for installing irrigation lines on a heap leach pad is illustrated, in accordance with various embodiments. Although described herein as being performed by one or more UAVs, the method 200 of the present disclosure is not limited in this regard. For example, the method 200 can be performed by aerial vehicles that are piloted and still be within the scope of this disclosure.

With combined reference to FIGS. 2, 3A, 3B, 4A, and 4B, the method 200 comprises lifting, via one or more UAVs 310, an irrigation line 320 (step 202), lifting, via one or more UAVs 310, an irrigation line 320 (step 204), transporting, via the one or more UAVs 310, the irrigation line 320 to the heap 110 (e.g., on a sloped surface 112 of the heap 110), and positioning, via the one or more UAVs 310, the irrigation line 320 on the heap 110 (e.g., on a sloped surface 112 of the heap 110, a top surface 114 of the heap 110, or the like) (step 206). In various embodiments, the method 200 further comprises placing, via the one or more UAVs 310, the irrigation line 320 on the heap 110 (step 208).

In various embodiments, prior to lifting the irrigation line 320, the irrigation line 320 is coupled to each of the one or more UAVs 310. The irrigation line 320 can be coupled to each of the one or more UAVs 310 manually (e.g., by personnel) or automatically (e.g., by the respective drone in the one or more UAVs 310), as described further herein. In this regard, the method 200 disclosed herein can be fully automated, semi-automated, or entirely controlled by one or more personnel (e.g., for manually coupling an irrigation line to each of the one or more UAVs 310, controlling, by a remote-control operation, operation of each of the one or more UAVs, releasing, by a remote-control operation, the irrigation line 320). The present disclosure is not limited in this regard, and various potential applications of the method 200 are within the scope of this disclosure and would be readily apparent to one skilled in the art.

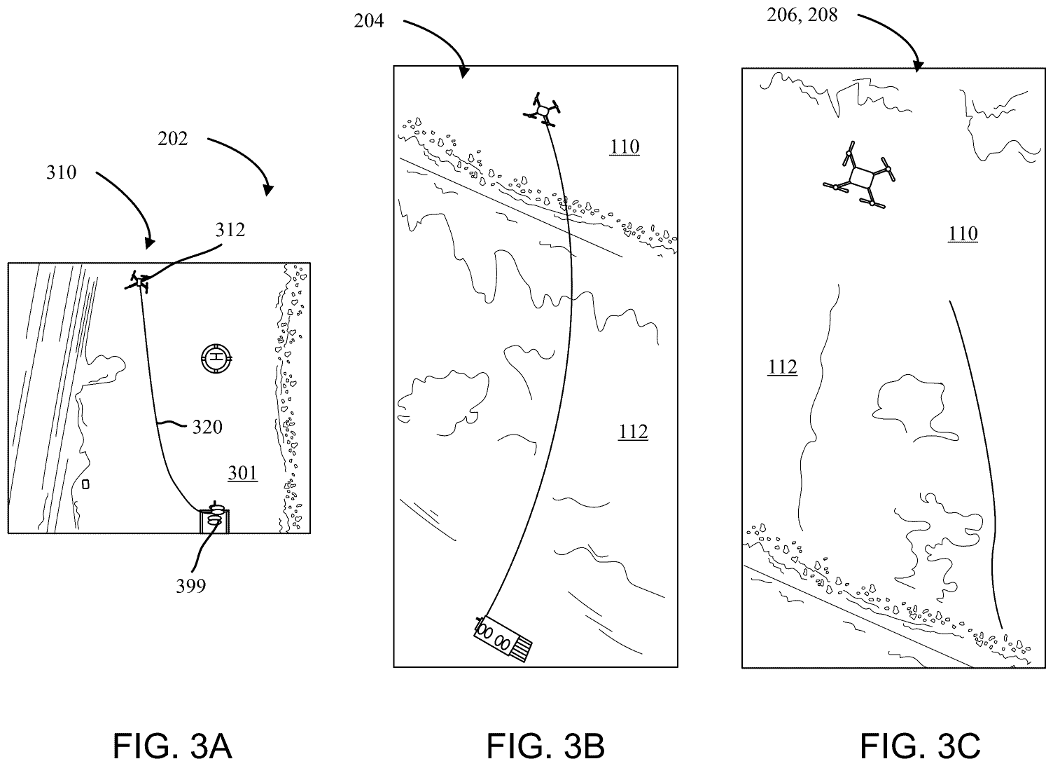

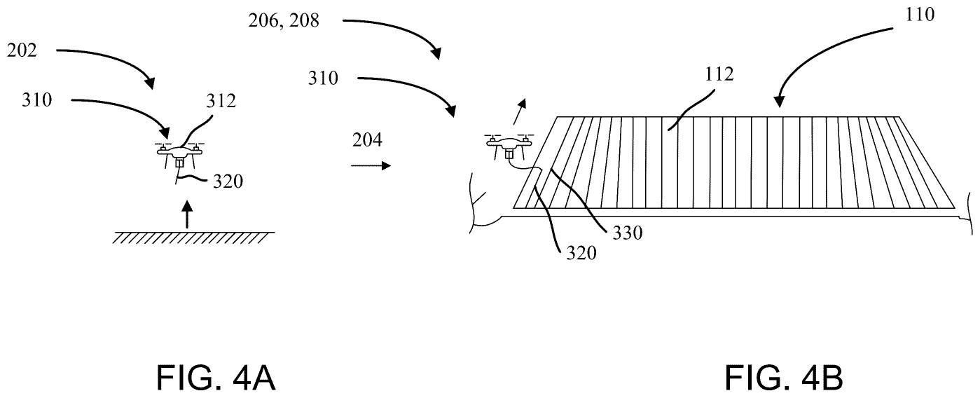

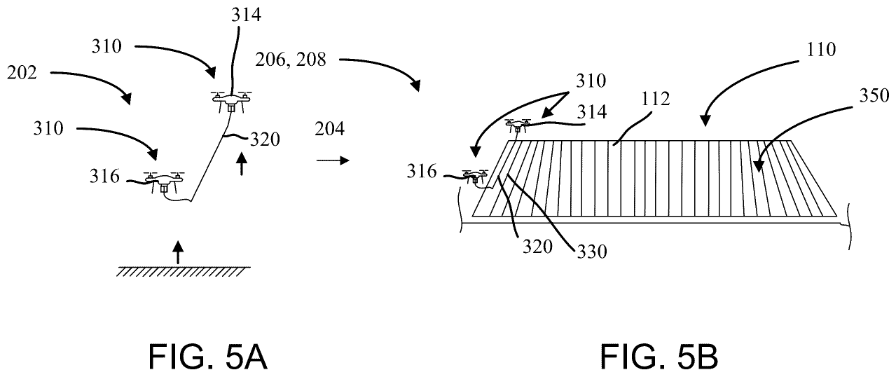

In various embodiments, as shown in FIGS. 3A, 4A, and 5A, the method 200 can include only one UAV (e.g., a UAV 312 from FIGS. 3A and 4A), two UAVs (e.g., UAV 314 and UAV 316 from FIG. 5A), or any other number of UAVs that may be readily apparent to one skilled in the art. In various embodiments, the method 200 can include more than two UAVs. The present disclosure is not limited in this regard. In various embodiments, with brief reference to FIG. 1, the greater a depth DI of a heap 110, the greater a length of an irrigation line to be placed on a respective sloped surface 112. Accordingly, as a length of an irrigation line increases, a total weight of the irrigation line increases proportionally. Stated another way, and in accordance with various embodiments, in order to lift a respective irrigation line 320, any number of the one or more UAVs 310 can be utilized in the method 200 and still be within the scope of this disclosure. Similarly, with brief reference to FIG. 3A, a portion of irrigation line 320 being placed by method 200 can be coupled to an apparatus 399 on the ground 301 (e.g., a spool, a support structure, or any other device for supporting a second end of an irrigation line 320 and/or for facilitating unwinding of an irrigation line 320). In this regard, the apparatus 399 can support a second end of the irrigation line 320 during at least a portion of method 200, in accordance with various embodiments. In various embodiments, the UAV 312 from FIG. 3A can unwind the irrigation line 320 from the apparatus 399 (e.g., a spool) during the transporting step (e.g., step 204) as shown in FIG. 3B.

In various embodiments, each of the UAVs in the one or more UAVs 310 comprises a handling assembly. The handling assembly is configured to secure and release a respective irrigation line (e.g., to place the irrigation line in accordance with step 208 of method 200). In this regard, at least one of the one or more UAVs 310 can include a handling assembly that comprises an irrigation line support structure (e.g., a harness, a truss, a winch, or any other irrigation line support structure that may be readily apparent to one skilled in the art) and a release mechanism (i.e., for releasing either a support structure with one or more irrigation lines coupled thereto, for releasing the one or more irrigation lines, independently or together, therefrom, or for releasing one or more irrigation lines from the winch). In various embodiments, when the handling assembly comprises a winch, the handling assembly can further comprise a placement mechanism (e.g., configured to guide and/or grip a respective irrigation line during the placing step 208 of method 200).

As described further herein, for a handling assembly with a support structure that comprises a harness or a truss, the respective UAV can be coupled to a harness or the truss via the release mechanism. In this regard, the release mechanism can be configured to secure and release the harness, which has one or more irrigation lines coupled thereto, and thereby release the irrigation line 320 onto a sloped surface 112 of a heap leach pad 100. In various embodiments, the release mechanism can be an element of the support structure. In this regard, the harness can be fixedly coupled to a respective UAV and the release mechanism can be configured to release each of the one or more irrigation lines coupled to the support structure (e.g., simultaneously, sequentially, in pairs, or any other ordered combination that may be readily apparent to one skilled in the art). In various embodiments, the release mechanism can be operable based on a control input from personnel, manually (e.g., by pulling a pin attached to a long string), or automatically (e.g., as determined by a central controller of the respective UAV). The present disclosure is not limited in this regard. In various embodiments, the harness can be coupled to an end of the irrigation line 320 (e.g., manually, automatically, or user control based) prior to the lifting step in step 202 of the method 200, and then released (e.g., manually, automatically, or user control based), once the irrigation line 320 is positioned in step 206, or placed in step 208. However, the present disclosure is not limited in this regard. For example, a release mechanism that is capable of coupling to an irrigation line 320 automatically (i.e., without user input) is within the scope of this disclosure.

As described further herein, for a handling assembly with a winch, a significant length of an irrigation line can be wound to a respective handling assembly of one of the one or more UAVs 310 prior to performing the method 200, in accordance with various embodiments. In various embodiments, a handling assembly without a winch as a support structure can be significantly less weight than a handling assembly with a winch as a support structure. In this regard, a greater number of irrigation lines can be placed in a single trip for a respective UAV with a handling assembly that includes a harness as the support structure relative to a handling assembly that includes a winch as the support structure, in accordance with various embodiments. However, a winch may provide more control for placement and allow a more automated placement process, in accordance with various embodiments.

In various embodiments, in step 204, the one or more UAVs 310 transport the irrigation line 320 from a staging area (e.g., as shown in FIGS. 3A, 3B, 4A and 5A) to the heap 110. In this regard, the one or more UAVs 310 can be controlled remotely, as described further herein, or be configured to automatically navigate to the heap 110. The present disclosure is not limited in this regard. During the transporting step 204, an entirety of the irrigation line 320 can be lifted off a ground surface. In this regard, the one or more UAVs 310 are configured to generate a lift force (e.g., via a propulsion system as described further herein) that is greater than a weight of the one or more UAVs 310 and the irrigation line 320 that is being transported. Although described herein as being lifted entirely off the ground, the present disclosure is not limited in this regard. For example, a portion of the irrigation line 320 could be disposed (i.e., towed) on the ground to allow the ground to support some of the weight of the irrigation line 320, a second end of an irrigation line could be fixed proximate (e.g., a fixed structure for apparatus 399 as shown in FIGS. 3A and 3B) a bottom location, a second end could be supported by a support structure that is adjustable at a bottom location (e.g., a spool for apparatus 399 as shown in FIGS. 3A and 3B), or any other arrangement of UAV and irrigation line 320 that may be readily apparent to one skilled in the art would still be within the scope of this disclosure.

In various embodiments, with reference now to FIGS. 3A-3C, in step 204, the one or more UAVs 310 transport the irrigation line 320 by unwinding the irrigation line 320 from an apparatus 399 (e.g., a spool) disposed in a staging area (e.g., as shown in FIG. 3A). In this regard, the apparatus 399 can provide support of some of the weight of the irrigation line 320 during the transporting step 204, which can allow the irrigation line 320 to be carried at once and/or facilitate less energy consumption by the UAV 312, in accordance with various embodiments. In various embodiments, the apparatus 399 comprises an anchor as opposed to a spool. In this regard, one end of the irrigation line 320 can be fixed by the apparatus 399, which can help facilitate alignment of the irrigation line 320 on the sloped surface 112 of the heap 110, prior to releasing the irrigation line 320 onto the heap 110.

In various embodiments, in step 206, the one or more UAVs 310 are configured to adjust a position of the irrigation line 320 on the heap 110 based on sensor data received from one or more sensors of the one or more UAVs 310. For example, the UAV 312 in FIG. 3B (or at least one of the UAVs 314, 316 from FIG. 4B) can be configured to receive real-time sensor data (e.g., from a position sensor for determining relative position to an adjacent irrigation line 330, a terrain sensor, a LiDAR sensor, or the like). In this regard, based on the sensor data received, the one or more UAVs 310 can adjust a position of the irrigation line 320 on the heap 110 in real time to be within the threshold parameters (e.g., spacing parameters, orientation parameters, or the like). Although described herein as utilizing sensor data for real-time adjustment of a position of the irrigation line in step 206, the present disclosure is not limited in this regard. For example, operation of the one or more UAVs 310 can be entirely user-controlled (e.g., via a remote device), and is still within the scope of this disclosure.

In various embodiments, the one or more UAVs 310 can be configured to maintain the irrigation line 320 within a desired envelope or orientation relative to an adjacent irrigation line. Although described herein as having the one or more UAVs orient the irrigation line 320 on the heap 110, the present disclosure is not limited in this regard. For example, the irrigation line 320 can be released onto the heap 110 and personnel can then proceed to orient the irrigation line 320 on the heap 110 as desired and would still be within the scope of this disclosure.

In various embodiments, the one or more UAVs 310 can be configured to maintain a threshold distance range, a threshold angle, or the like from an adjacent irrigation line (e.g., irrigation line 330 in FIGS. 3B and 4B). For example, the one or more UAVs 310 can be configured to position the irrigation line 320 that is being positioned and placed by the method 200 between 1 foot (0.3 meters) and 3 feet (0.9 meters), or approximately 2 feet (0.6 meters). Similarly, the one or more UAVs 310 can be configured to maintain a substantially parallel orientation relative to an adjacent irrigation line 330. In various embodiments, substantially parallel is between −15° and 15°, or approximately 0°. In this regard, the one or more UAVs 310 can be configured to position each irrigation line in an irrigation system 350 installed in accordance with the method 200 to facilitate a uniform distribution of raffinate solutions across the surfaces of the heap 110, which could otherwise be hindered by inaccessible, or hard to reach, sloped surface 112, in accordance with various embodiments. Although described herein as maintaining a threshold distance range via the one or more UAVs 310, the present disclosure is not limited in this regard. For example, operation of the one or more UAVs 310 can be entirely user-controlled (e.g., via a remote device), and the irrigation line 320 can be adjusted after being released from the one or more UAVs 310, in accordance with various embodiments.

In various embodiments, for respective UAVs in the one or more UAVs 310 with a handling assembly that comprises a release mechanism, the positioning step 206 can further comprise releasing, via a handling assembly of at least one of the one or more UAVs 310, the irrigation line 320 onto the heap 110. In this regard, the release mechanism can release a single irrigation line from the respective UAV, all of a plurality of irrigation lines simultaneously from the respective UAV, a first pair of irrigation lines followed by a second pair of irrigation lines, or any other ordered combination that may be readily apparent to one skilled in the art. In this regard, a single UAV (e.g., as shown in FIG. 3A) can be configured to carry the irrigation line 320 and release the irrigation line 320 onto the sloped surface 112 of the heap 110. Once the irrigation line 320 has been released, personnel can make any adjustments to the orientation of the irrigation line 320 on the sloped surface 112, in accordance with various embodiments. Additionally, if the irrigation line 320 were coupled to a support structure (e.g., a harness) that was released with the irrigation line 320, personnel can de-couple the irrigation line 320 from the harness and install the irrigation line 320 to a respective irrigation system, in accordance with various embodiments.

In various embodiments, for respective UAVs in the one or more UAVs 310 with a handling assembly that comprises a winch, the positioning step 206 can further comprise unwinding, via a handling assembly of at least one of the one or more UAVs 310, the irrigation line 320 on the heap 110. In this regard, at least one of the one or more UAVs 310 (e.g., UAV 312 from FIG. 3B or UAV 314 from FIG. 4B) can unwind the irrigation line 320 from the handling assembly (e.g., a winch or any other type of mechanical spool or belt). In various embodiments, when more than one UAVs are used, a second UAV in the one or more UAVs 310 (e.g., UAV 316 from FIG. 4B), can manage the positioning and placing steps (i.e., steps 206 and 208), while the UAV 314 unwinds the irrigation line 320. However, the present disclosure is not limited in this regard. For example, each of the one or more UAVs 310 can unwind a portion of the irrigation line 320 and simultaneously perform the positioning step 206 and/or placement step 208 and still be within the scope of this disclosure.

In various embodiments, the positioning step 206 can further comprise aligning the irrigation line within a respective envelope of a desired placement location. The aligning can be performed via user-control (e.g., via a remote control) or automatically by the one or more UAVs 310. The present disclosure is not limited in this regard. Accordingly, when the positioning step includes user-controlled alignment of the irrigation line, the placement step 208 can comprise releasing (e.g., by a control input from a user), the irrigation line 320 from the one or more UAVs 312. Stated another way, after a user has aligned the irrigation line 320 (e.g., visually, or based on camera data received by the user from the one or more UAVs 310), the user can release the irrigation line 320 from the one or more drones (e.g., via a release input sent from a remote control), in accordance with various embodiments.

In various embodiments, as described previously herein, the method 200 can facilitate installation of irrigation lines on the sloped surface 112 of the heap 110 with a significant depth (e.g., a depth of greater than 1,000 feet (305 meters)). In this regard, a greater recovery of metal can be achieved by utilizing an irrigation system installed in accordance with the method 200 relative to typical irrigation systems, which typically include maximum depths of around 600 feet (183 meters).

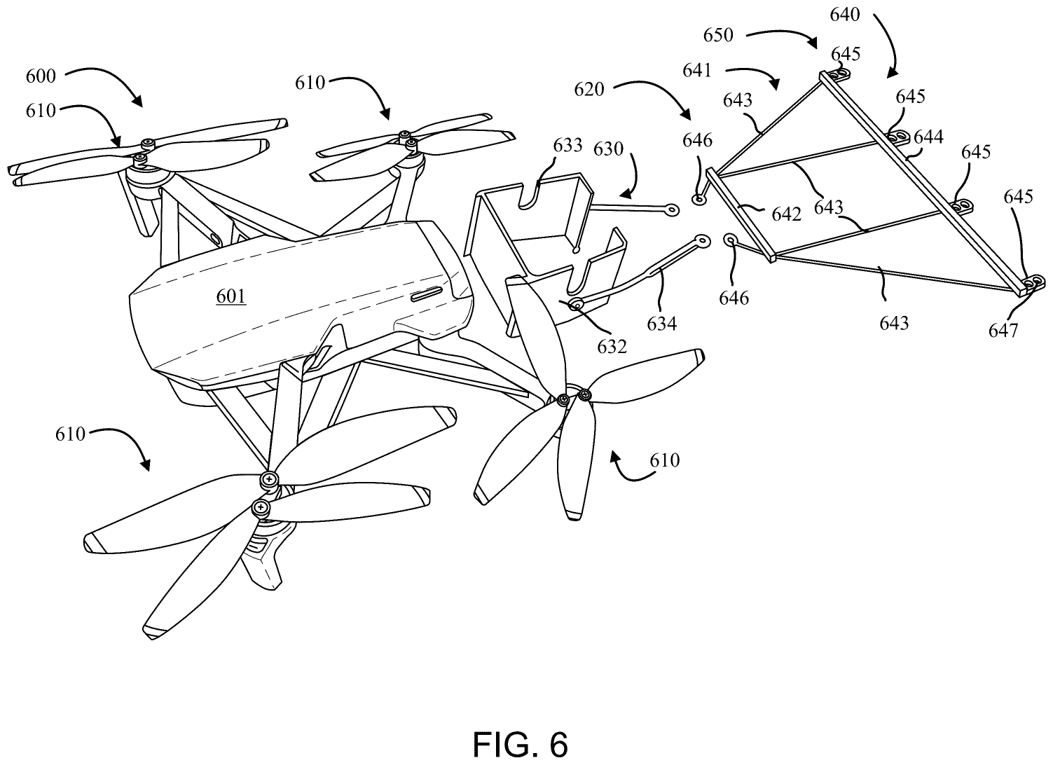

Referring now to FIG. 6, an exploded view of a UAV 600 for precise placement of irrigation lines on a heap is illustrated in accordance with various embodiments. In various embodiments, each of the one or more UAVs 310 from FIGS. 3A, 3B, 3C, 4A, 4B, 4C is in accordance with the UAV 600. In various embodiments, only one of the one or more UAVs 310 from FIGS. 5A and 5B is in accordance with the UAV 600, as described further herein. The present disclosure is not limited in this regard. The UAV 600 comprises a UAV body 601, a propulsion system 610 and an irrigation line support structure 620. Although FIG. 6 is illustrated as including similar features to smaller UAVs, the present disclosure is not limited in this regard. More specifically, the UAV 600 could be any size or configuration capable of (and adapted to) lifting and placing irrigation lines, in accordance with various embodiments.

In various embodiments, the irrigation line support structure 620 comprises a handling assembly 630. In various embodiments, the irrigation line support structure 620 can comprise a mount 632 and a harness 640. The mount 632 can be configured to be coupled to the UAV body 601 of the UAV 600 (e.g., fixedly or removably). For example, the mount 632 can comprise one or more slots 633 configured to facilitate mounting the mount 632 to the UAV body 601. Although illustrated with the one or more slots 633, the mount 632 is not limited in this regard, and any mounting arrangement that may be readily apparent to one skilled in the art is within the scope of this disclosure. Although the handling assembly 630 is illustrated as a separate component from the UAV body 601, the present disclosure is not limited in this regard. For example, the handling assembly 630 can be integral with the UAV body 601, which is still within the scope of this disclosure.

In various embodiments, the harness 640 comprises a truss structure 641. Any type of truss arrangement could be utilized and would be readily apparent to one skilled in the art. For example, cross-beams could be employed through the center of the truss structure 641 to provide additional structural rigidity and reduce an amount of twisting that may occur during a transporting step (e.g. step 804 of method 800 as described further herein), in accordance with various embodiments.

In various embodiments, the harness 640 can comprise a truss structure 641. In this regard, the truss structure 641 can comprise a top beam 642, a bottom beam 644, and a plurality of support beams 643 (e.g., rigid beams, ropes, cables, or any other support beam for a truss structure that may be readily apparent to one skilled in the art) that connect the top beam 642 to the bottom beam 644. In various embodiments, the harness 640 can comprise one or more attachment beams 646 configured to couple the truss structure 641 to the mount 632. In this regard, each of the one or more attachment beams 646 can comprise an aperture configured as a mounting point to couple the truss structure to a mating component (e.g., a pivot arm 634). Although illustrated as including the mount 632 and the harness 640 as separate components, the present disclosure is not limited in this regard. For example, the mount 632 and the harness 640 could be integrally formed (i.e., formed from a single piece of material, or monolithic) and would still be within the scope of this disclosure. In various embodiments, the harness 640 can be pivotably coupled to the mount 632 (e.g., via one or more of the pivot arm 634). In this regard, the harness 640 may be configured for a range of motion during operation to prevent stress concentrations or other potential structural damage during performance of the method 200 from FIG. 2. Stated another way, the harness 640 can have a freedom of movement about a pivot axis during a transporting step (e.g., step 804 of method 800 as described further herein). However, the present disclosure is not limited in this regard. For example, the harness 640 could be fixedly coupled to the mount 632 and would still be within the scope of this disclosure. In various embodiments, by having the mount 632 as a separate component from the main body, the mount 632 and consequently the harness 640 can be configured to be releasable from the UAV body 601 (e.g., during the releasing step 808 of method 800 as described further herein). In this regard, the mount 632, the harness 640, and each of the one or more irrigation lines that are coupled to the one or more attachment mechanisms can be released together, and personnel can manually decouple the irrigation lines from the one or more attachment mechanisms to manually adjust a placement of each of the one or more irrigation lines after release.

In various embodiments, the harness 640 is configured to couple to one or more irrigation lines. For example, the harness 640 can comprise one or more flanges 645, each of the one or more flanges 645 comprise an anchor point 647. In various embodiments, the anchor point 647 comprises one or more apertures (e.g., for fixedly coupling an irrigation line thereto), a clamp (e.g., for securing and releasing an irrigation line), or any other fastener arrangement for securing an irrigation line thereto. In various embodiments, the anchor point 647 can comprise a mechanical fastener (e.g., that can be tightened and loosened manually) or an electronically controlled fastener (e.g., an electro-mechanical actuator or any other electronically controlled fastener that may be readily apparent in the art). In this regard, the anchor point 647 on each of the one or more flanges 645 can be configured to facilitate manually coupling an irrigation line thereto and either manually or electronically decoupling the irrigation line therefrom. For example, decoupling the irrigation line from the UAV body 601 can be performed in response to electronically dropping the harness 640 in the placement step 208 from FIG. 2, in accordance with various embodiments, or decoupling the irrigation line can be performed by electronically decoupling the irrigation line from the harness 640 in response to dropping the irrigation line directly in the placement step 208 from FIG. 2. The present disclosure is not limited in this regard.

In various embodiments, the anchor point 647 for each of the one or more flanges 645 comprises an attachment mechanism (e.g., an electronically controlled attachment mechanism). For example, in various embodiments, the attachment mechanism can be controlled remotely. In this regard, each of the one or more attachment mechanisms can be configured to release a respective irrigation line attached thereto in response to receiving a command from a remote control as described further herein. However, the present disclosure is not limited in this regard. For example, a placement mechanism 650 of the UAV 600 can comprise a plurality of release mechanisms. In this regard, each of the plurality of release mechanisms can correspond to a respective irrigation line. Stated another way, the anchor point 647 of each of the one or more flanges 645 can comprise a release mechanism that is configured to receive a control input (e.g., electrically or electronically) to release a respective irrigation line therefrom as described further herein. The release mechanism can comprise an electronically controlled actuator, an electronically controlled clamp, an electronically controlled cam, or any other electronically controlled attachment device that may be readily apparent to one skilled in the art. The present disclosure is not limited in this regard.

In various embodiments, the anchor point 647 for each of the one or more flanges 645 comprises one or more apertures configured for securing an irrigation line thereto. In this regard, the harness 640 can be configured to secure irrigation lines manually thereto. In such an embodiment, instead of the placing step 208 in method 200 from FIG. 2, the UAV 600 could land (e.g., on a top surface 114 of a heap 110) and an individual could manually release the respective irrigation line from the UAV 600), or the UAV 600 could be configured to release the harness 640 entirely from the UAV body 601, or the UAV could be configured to release the irrigation line support structure 620 from the UAV body 601. The present disclosure is not limited in this regard.

In various embodiments, the harness 640 disclosed herein can be sized and configured to carry an optimal number of irrigation lines for a respective application. In this regard, the harness 640 can be sized and configured based on a maximum carrying capacity and a maximum number of irrigation lines to be placed that would remain below the maximum carrying capacity. However, the present disclosure is not limited in this regard, and any number of the anchor point 647 for coupling a respective irrigation line to the UAV 600 is within the scope of this disclosure.

In various embodiments, each of the one or more flanges 645 comprises a respective attachment mechanism. In this regard, the placement mechanism 650 can comprise a release mechanism coupled to each of the one or more flanges 645 and be configured to secure the respective irrigation line to the respective flange during transport. In various embodiments, each of the one or more attachment mechanisms can comprise a clamp (e.g., configured to transition between a retracted state and a deployed state and either remote-controllable or manual), a fastener (e.g., a bolt) configured to provide a compressive force to retain an irrigation line, or any other securement type mechanism known in the mechanical arts. In this regard, each of the one or more attachment mechanisms associated with the one or more flanges 645 is configured to indirectly couple an irrigation line to the UAV body 601 for transporting the respective irrigation line, in accordance with various embodiments.

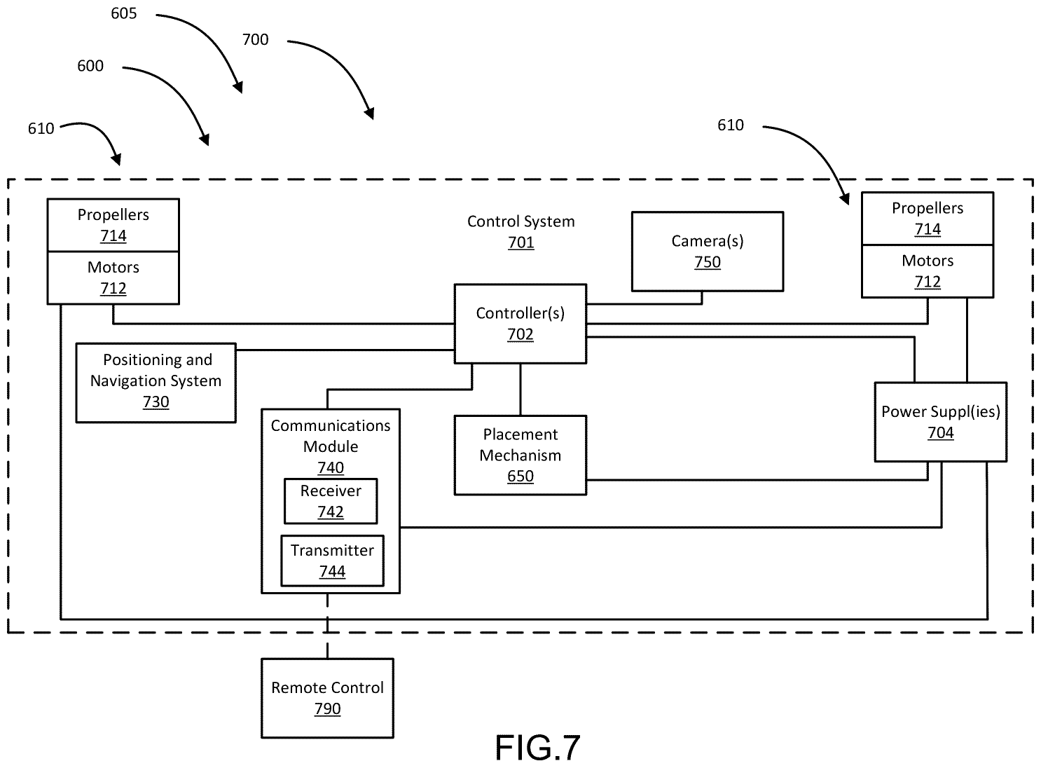

Referring now to FIG. 7, a schematic view of an Unmanned Aircraft System (“UAS”) with a control system 701 for the UAV 600 from FIGS. 6 and 7 is illustrated with like numerals depicting like elements, in accordance with various embodiments. In various embodiments, the UAS 605 includes the UAV 600 and a remote control 790 configured to control the UAV 600 (e.g., via communication with the control system 701). Although illustrated as including the remote control 790, the present disclosure is not limited in this regard. For example, a UAS 605 that is fully autonomous is within the scope of this disclosure as described further herein and is illustrated with like numerals depicting like elements, in accordance with various embodiments. In various embodiments, the control system 701 comprises the one or more controllers 702, one or more motors 712 of the propulsion system 610, the positioning and navigation system 730, and a communications module 740. The one or more controllers 702 are in operable communication with the propulsion system 610, the placement mechanism 650, and the positioning and navigation system 730. In this regard, as described further herein, the one or more controllers 702 are configured to operate various components of the UAV 600 during the method 200 for irrigation line installation from FIG. 2 as described further herein.

In various embodiments, the UAV 600 can further comprise one or more cameras 750. In this regard, for a remote-controlled embodiment, the one or more cameras 750 can provide real-time visual data to a user controlling operation of the UAV 600. In this regard, a user can more accurately and/or precisely place an irrigation line, in accordance with various embodiments. In various embodiments, one or more cameras 750 could also be utilized in a fully autonomous embodiment of the UAV 600. For example, the visual data from the one or more cameras 750 could be transmitted to a database (e.g., through the communications module 740) for use in machine learning models to improve operation of the UAV 600 that is fully autonomous, in accordance with various embodiments.

In various embodiments, a controller in the one or more controllers 702 may be configured as a central network element or hub to access various systems and components of the UAV 600 (e.g., a main controller, a central controller, or the like). A controller in the one or more controllers 702 may comprise a network, a computer-based system, and/or software components configured to provide an access point to various systems, engines, and components of UAV 600. In various embodiments, each of the one or more controllers 702 comprises a processor. In various embodiments, the one or more controllers 702 can be implemented in a single processor. In various embodiments, each of the one or more controllers 702 can be implemented and may include one or more processors and/or one or more tangible, non-transitory memories and be capable of implementing logic. Each of the one or more processors can be a general-purpose processor, a digital signal processor (DSP), an application-specific integrated circuit (ASIC), a field-programmable gate array (FPGA) or other programmable logic device, discrete gate or transistor logic, discrete hardware components, or any combination thereof. The one or more controllers 702 can comprise one or more processors configured to implement various logical operations in response to execution of instructions; for example, instructions stored on a non-transitory, tangible, computer-readable medium (e.g., one or more memories) configured to communicate with one or more controllers 702.

System program instructions and/or controller instructions may be loaded onto a non-transitory, tangible, computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In various embodiments, the one or more controllers 702 of the UAV 600 can include a plurality of controllers. For example, the placement mechanism 650 can include a local controller in the one or more controllers 702 that can communicate with a main controller in the one or more controllers 702 to perform various functions as described further herein and still be within the scope of this disclosure. In various embodiments, the one or more controllers 702 can be only a single controller for the UAV 600. The present disclosure is not limited in this regard.

In various embodiments, each of the electronic components of the UAV 600 is coupled to one or more power supplies 704. In various embodiments, the one or more power supplies 704 can comprise a battery (e.g., a rechargeable battery). In various embodiments, the one or more power supplies 704 can include any suitable rechargeable battery including lithium ion, lithium iron phosphate (LFP), silver oxide, or nickel zinc, among other types of rechargeable batteries. In various embodiments, the one or more power supplies 704 can be charged and discharged multiple times.

In various embodiments, the propulsion system 610 comprises one or more propellers 714 and one or more motors 712 operably coupled to the one or more propellers 714. Although illustrated as being an electrically powered UAV, the UAV 600 is not limited in this regard. For example, a UAV 600 powered by an internal combustion engine (“ICE”), a gas-turbine engine, a hybrid gas-electric engine, a hydrogen-powered engine, or the like is within the scope of this disclosure. In various embodiments, the one or more controllers 702 are in operable communication with the propulsion system (e.g., the motors 712). In this regard, the one or more controllers 702 can be configured to adjust a thrust (e.g., a lift force) for the propulsion system 610, adjust a speed of the propellers 714, or the like. In this regard, the one or more controllers 702 can be configured to maneuver the UAV 600 via the propulsion system 610, in accordance with various embodiments (e.g., in accordance with the lifting step 202 and transporting step 204 of method 200 from FIG. 2).

In various embodiments, the communications module 740 is configured to receive commands from the remote control 790 (e.g., a remote-control interface). In this regard, the control system 701 can be operable by a user from a remote location via the remote control 790, in accordance with various embodiments. However, the present disclosure is not limited in this regard. For example, the control system 701 can be a fully autonomous control system that is configured to place irrigation lines without any external input. In this regard, the UAV 600 can be configured to map a heap (e.g., heap 110 from FIG. 1) prior to performing the method 200 from FIG. 2 for installing the irrigation lines, in accordance with various embodiments. In various embodiments, the heap 110 from FIG. 1 can be mapped by another UAV and the respective map can be stored in the control system 701 (e.g., within a memory of the one or more controllers 702 or the like). In this regard, the map of the heap 110 can be utilized by the one or more controllers 702 of the control system 701 during method 200 from FIG. 2, in accordance with various embodiments.

In various embodiments, the remote control 790 includes a remote-control interface configured to enable real-time adjustments, position monitoring, and/or supervision of the placing of the irrigation line. For example, the control interface can comprise a display, one or more joysticks, or the like. The display can be configured to display visual data from the positioning and navigation system 730 and/or from the one or more cameras 750. In various embodiments, the remote control 790 comprises a transmitter and a receiver (e.g., individually or combined as a transceiver). In this regard, the remote control 790 is configured to transmit control signals to the control system 701 of the UAV 600 and receive data from the control system 701 via communication with the communications module 740, in accordance with various embodiments.

In various embodiments, the placement mechanism 650 further comprises one or more sensors 736. Although described further herein as including one or more sensors 736, the present disclosure is not limited in this regard. For example, an embodiment without sensors could be utilized and would still be within the scope of this disclosure.

In various embodiments, the communications module 740 comprises a receiver 742 and a transmitter 744. Although illustrated as being separate components, the present disclosure is not limited in this regard. For example, the transmitter 744 and the receiver 742 can form a transceiver and still be within the scope of this disclosure. In various embodiments, the receiver 742 is configured to receive control commands from the remote control 790.

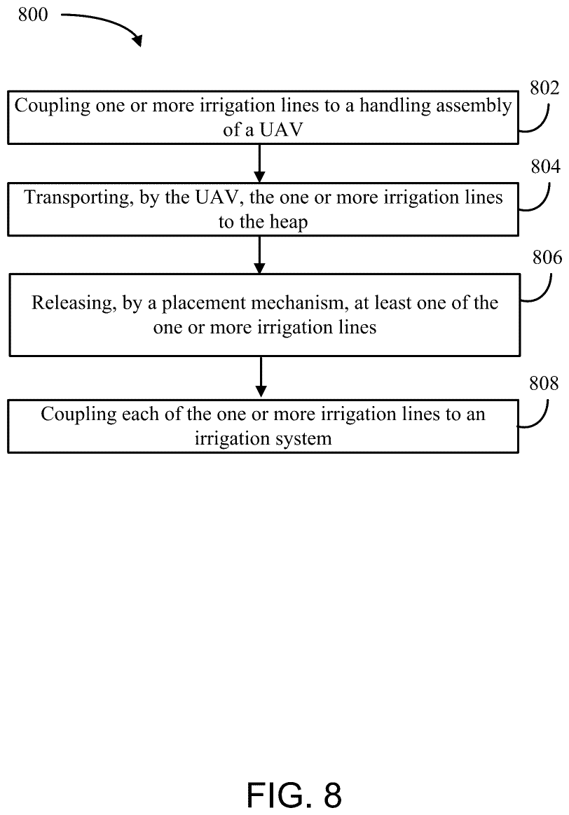

Referring now to FIG. 8, a method 800 for forming an irrigation system for a heap leach pad is illustrated in accordance with various embodiments. With combined reference to FIGS. 6, 7 and 8, the method 800 comprises coupling one or more irrigation lines to an irrigation line support structure 620 of a UAV 600 (step 802). For example, an irrigation line can be coupled to the anchor point 647 of each of the one or more flanges 645 of the harness 640. In various embodiments, the coupling can be performed manually by personnel (e.g., via mechanical fasteners, via a mechanically biased clamp, via an electronically biased clamp, or by any other fastener arrangement that may be readily apparent to one skilled in the art.

The method 800 further comprises transporting, by the UAV 600, the one or more irrigation lines to the heap (step 804). In this regard, the UAV 600 can be controlled by the remote control 790 to lift and transport at least a portion of the one or more irrigation lines from a staging area (e.g., as shown in FIGS. 3A and 3B).

In various embodiments, the method 800 further comprises releasing, by the placement mechanism 650, at least one of the one or more irrigation lines (step 806). In this regard, the placement mechanism 650 can comprise a release mechanism that is configured to release the irrigation line support structure 620 entirely, a release mechanism that is configured to release the harness 640 entirely, or a plurality of release mechanisms where each of the plurality of release mechanisms is configured to release a respective irrigation line. The present disclosure is not limited in this regard.

In various embodiments, the releasing in step 806 can be a control input received by the one or more controllers 702 from the remote control 790 through the communications module 740. In various embodiments, a user can provide the control input based on communication with other personnel that is proximate the placement location, based on the user's personal visibility of the UAV 700, or based on visual data that is received in real time on the remote control 790 from the one or more cameras 750. The present disclosure is not limited in this regard.

In various embodiments, the method 800 further comprises coupling each of the one or more irrigation lines to the irrigation system of the heap leach pad (step 808). In this regard, after the releasing step 806, each of the one or more irrigation lines is released from the UAV and is disposed on the heap 110 from FIG. 1. In this regard, if each of the irrigation lines were released individually, each of the one or more irrigation lines can be coupled to the irrigation system for the heap pad by personnel at the top surface 114 of the heap 110 from FIG. 1. In various embodiments, if the irrigation line support structure 620 was released entirely (e.g., with the harness 640), the method can further comprise decoupling each of the one or more irrigation lines from the harness 640 prior to coupling each of the one or more irrigation lines to the irrigation system.

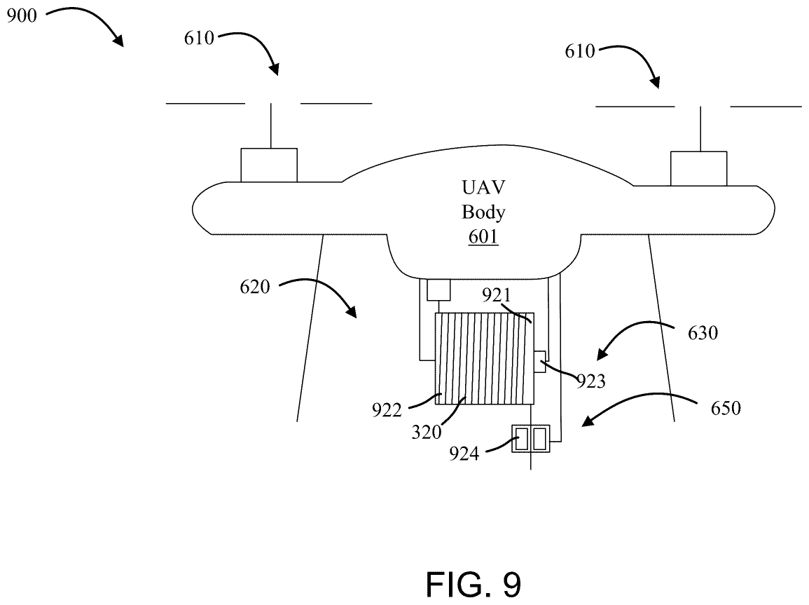

Referring now to FIG. 9, a front view of a UAV 900, with like numerals depicting like elements is illustrated, in accordance with various embodiments. In various embodiments where the irrigation line support structure 620 includes the winch 922, the winch 922 comprises a drum 921. The drum 921 is configured to have an irrigation line (e.g., irrigation line 320 from FIGS. 3A, 3B, 4A, 4B, 5A, 5B) wound thereon. In this regard, the winch 922 is configured to wind (or unwind) an irrigation line 320 around the drum 921 during operation of the UAV 900 and while performing the installation method 200 from FIG. 2. In various embodiments, the winch 922 further comprises a motor 923 operably coupled to the drum 921. In this regard the motor 923 is configured to rotate the drum 921 about a drum axis in order to facilitate winding (or unwinding) of the irrigation line 320 during the method 200 from FIG. 2 as described further herein. Although described herein as including a winch 922, the handling assembly 630 is not limited in this regard. For example, the handling assembly 630 could comprise a hoist and still be within the scope of this disclosure.

In various embodiments where the handling assembly 630 of the irrigation line support structure 620 includes the winch 922, the placement mechanism 650 comprises a gripping mechanism, a guiding mechanism, or any other device adaptable to secure and release an irrigation line or guide an irrigation line (e.g., placing device 924). In this regard, the placement mechanism 650 can be configured to securely grasp and release an irrigation line (e.g., during the positioning step 206 and placement step 208 of method 200). For example, the placing device 924 can comprise a gripper (e.g., an end of arm tooling device adaptable to manipulate an object), a pivoting or swinging gripping mechanism, a gripping mechanism with a rotary actuator, a cam actuated gripping mechanism, a linear actuated gripping mechanism, or any other gripping mechanism that may be readily apparent to one skilled in the art. In various embodiments, the placing device 924 comprises a guiding mechanism (i.e., a mechanism that guides the irrigation line as it is being positioned and placed in steps 206 and 208 of method 200). For example, the placing device 924 can comprise a contoured shape configured to guide the irrigation line onto the sloped surface 112 of the heap 110 from FIG. 1 during installation (i.e., during the positioning step 206 and/or placement step 208 of method 200 from FIG. 2), in accordance with various embodiments. In various embodiments, the placing device 924 can comprise a combination of a gripping mechanism and a guiding mechanism. The present disclosure is not limited in this regard. In various embodiments, if the placing device 924 comprises a gripping mechanism, the gripping mechanism can allow movement of an irrigation line after the irrigation line is placed, providing additional adaptability after placement of an irrigation line relative to a guiding mechanism. In various embodiments, if the placing device 924 comprises a guiding mechanism, a positioning of the irrigation line can be adjusted by altering a position of the guiding mechanism to facilitate fast and efficient positioning of the irrigation line, in accordance with various embodiments.

In various embodiments, in a multi-UAV system (e.g., as shown in FIGS. 5A and 5B), one of the UAVs (e.g., UAV 314 from FIG. 5B) could be the UAV 900 from FIG. 9, and a second of the UAVs (e.g., UAV 316 from FIG. 4B) could be the UAV 600 from FIG. 6, and the UAVs could operate together to position and place the irrigation line 320 (e.g., in accordance with steps 206, 208 of method 200). Similarly, if more than two UAVs are utilized, one UAV could have the winch 922 and a remaining number of UAVs could have attachment mechanisms, and the plurality of UAVs could be configured to position and place the irrigation line 320 in steps 206, 208 of method 200 from FIG. 2, in accordance with various embodiments. The present disclosure is not limited in this regard.

In various embodiments, in a multi-UAV system (e.g., as shown in FIGS. 5A and 5B), one of the UAVs (e.g., UAV 314 from FIG. 5B) could be the UAV 900 from FIG. 9, and include only a winch 922 for the handling assembly 630 and a second of the UAVs (e.g., UAV 316 from FIG. 4B) could include only a placing device 924 for the handling assembly 630 and the UAVs (e.g., UAVs 314, 316) could operate together to position and place the irrigation line 320 (e.g., in accordance with steps 206, 208 of method 200). Similarly, if more than two UAVs are utilized, one UAV could have the winch 922 and a remaining number of UAVs could have the placing device 924, and the plurality of UAVs could be configured to position and place the irrigation line 320 in steps 206, 208 of method 200 from FIG. 2, in accordance with various embodiments. The present disclosure is not limited in this regard.

In this regard, with brief reference back to FIGS. 5A and 5B, disclosed herein is a UAV system comprising a plurality of UAVs (e.g., UAV 314 and UAV 316). The UAVs 314, 316 are configured to operate together to lift, position, and place an irrigation line on a heap 110. In various embodiments, one of the UAVs (e.g., UAV 314) in the UAV system of FIGS. 5A and 5B includes the winch 922 from FIG. 8 and one of the UAVs (e.g., UAV 316) includes the placing device 924. In this regard, the UAV 316 can be configured for placing and aligning the irrigation line 320 and the UAV 314 can be configured for unwinding the irrigation line 320. In various embodiments, as described further herein, the UAVs 314, 316 can communicate with each other (e.g., through communications modules) to facilitate accurate placement of the irrigation line 320.

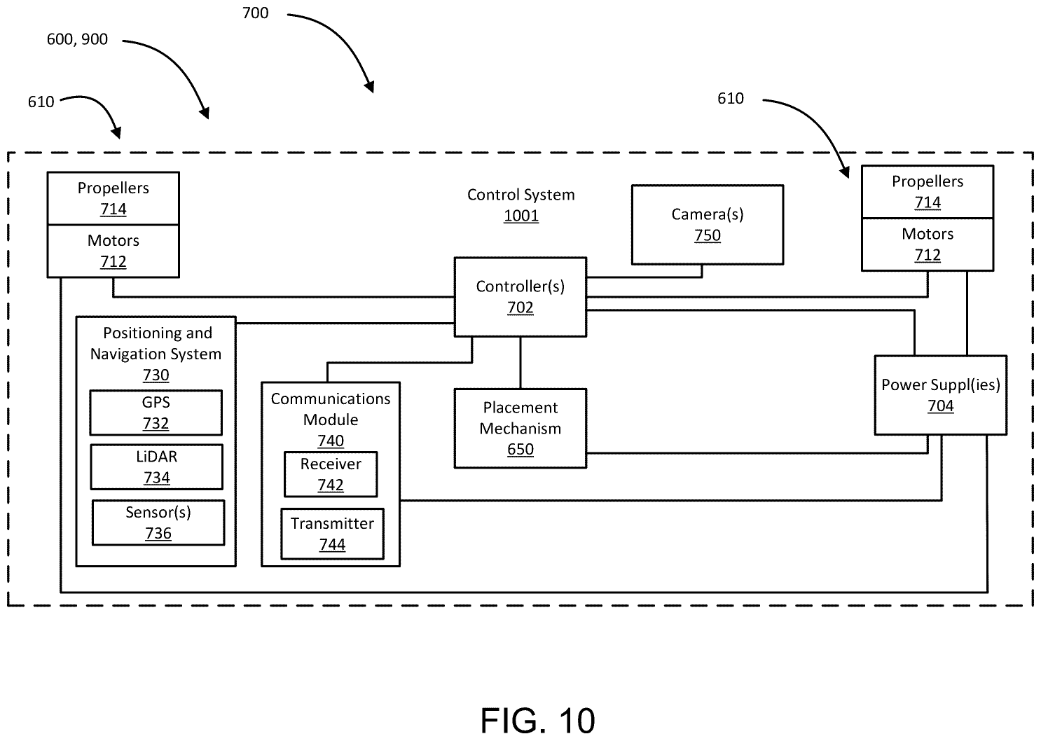

Referring now to FIG. 10, a UAV 600, 900 that includes a control system 1001 for performing the method 200 from FIG. 2 in an autonomous (or semi-autonomous) manner is illustrated, in accordance with various embodiments, with like numerals depicting like elements.

In various embodiments, the one or more controllers 702 are configured to store (e.g., in one or more memories), regional survey data and/or benchmark coordinates associated with the heap 110 from FIG. 1. In this regard, the one or more controllers 702 can be configured to position the irrigation line based on the regional survey data and/or the benchmark coordinates associated with the heap 110. Although described herein as utilizing pre-set benchmark coordinates, the present disclosure is not limited in this regard. For example, the one or more controllers 702 can be configured to command the UAV 600 to perform a benchmark survey of the heap 110 from FIG. 1, map out the heap 110 accordingly, and determine an irrigation system layout based on the heap 110 that is surveyed and still be within the scope of this disclosure. In various embodiments, a heap irrigation installation system can include a plurality of UAVs including a set of surveying UAVs and a set of installation UAVs. In this regard, the set of surveying UAVs can perform the initial mapping and benchmarking of the heap 110 and determine an irrigation system layout based on the initial mapping and benchmarking, and the set of installation UAVs can receive the irrigation system layout from the set of surveying UAVs and install a plurality of irrigation lines based on the systems and methods disclosed herein based on the initial mapping and benchmarking.

In various embodiments, the positioning and navigation system 730 comprises a global positioning system (“GPS”) 732, a light detection and ranging (“LiDAR”) system 734, and/or any additional sensors (e.g., one or more sensors 736) configured to facilitate UAV positioning and navigation to facilitate the method 200 from FIG. 2. In various embodiments, the one or more sensors 736 are configured to provide data to the one or more controllers 702 that help facilitate navigation of the UAV 600 and positioning of the irrigation line during method 200 of FIG. 2. In various embodiments, the one or more sensors 736 are not mutually exclusive. For example, a position sensor to provide data related to a position of an irrigation line during the positioning step 206 and/or placement step 208 of method 200 from FIG. 2 can be a component of the handling assembly 630 and/or the placement mechanism 650 and the positioning and navigation system 730, in accordance with various embodiments. The present disclosure is not limited in this regard.

In various embodiments, the receiver 742 is configured to receive data transmitted from another UAV in the one or more UAVs from FIGS. 5A and 5B. For example, with brief reference to FIGS. 5A and 5B and in accordance with various embodiments, the UAV 314, 316 can be fully autonomous and configured to communicate with one another. In this regard, tension data measured from one UAV (e.g., UAV 314) related to a tension of the irrigation line being placed in step 208 of method 200 can be relayed to the UAV 316 that is positioning the irrigation line 320 on the heap 110. Accordingly, based on the data being communicated between the UAVs 314, 316, the UAVs 314, 316 can accurately position and place the irrigation line 320 on the heap 110 as described previously herein.

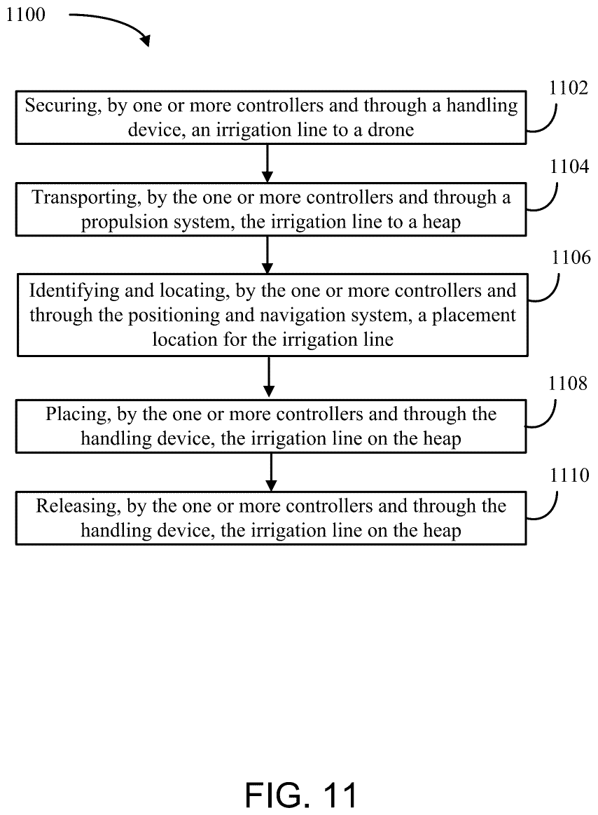

Referring now to FIG. 11, a flow chart of a process 1100 performed by the control system 1001 of the UAV 600, 900 from FIG. 10 is illustrated, in accordance with various embodiments. With combined reference now to FIGS. 6-11, the process 1100 comprises securing, by the one or more controllers 702 and through a handling assembly 630 and/or a placement mechanism 650, an irrigation line (e.g., irrigation line 320 from FIGS. 3A, 3B, 3C, 4A, 4B, 5A, 5C) to the UAV 600 (step 1102). For the irrigation line support structure 620 that comprises the harness 640, the irrigation line can be coupled to one of the one or more attachment mechanisms for each of the respective one or more flanges 645. For the irrigation line support structure 620 that comprises a winch 922, an irrigation line can be coupled to a winch 922 of the handling assembly 630 and wound thereon. In various embodiments, the irrigation line can be coupled to the handling assembly 630 (e.g., with the winch 922 or the harness 640) manually or automatically. The present disclosure is not limited in this regard. For example, a first end of the irrigation line to be installed can be coupled to the winch 922 or the harness 640 by a user, or the control system 1001 can be configured to detect and engage the first end of the irrigation line. After the first end of the irrigation line is coupled to the winch 922, the irrigation line 320 can be wound around the drum 921 of the winch 922, in accordance with various embodiments. For example, the one or more controllers 702 can command the motor 923 to rotate in a first direction to wind the irrigation line 320 about the drum 921, in accordance with various embodiments.

In various embodiments, for UAV 900 from FIG. 9, the placing device 924 can be configured to provide data to the one or more controllers 702 (e.g., via one of the one or more sensors 736) during the winding process. In various embodiments, in response to detecting a second end of the irrigation line 320, the one or more controllers 702 can stop the winding process and secure the irrigation line 320 proximate the second end of the irrigation line 320 (e.g., via the placing device 924). However, the present disclosure is not limited in this regard. For example, the winch 922 can be configured to wind a set length of an irrigation line or the amount of the irrigation line that is wound on the winch can be set manually.

In various embodiments, a winding speed of the winch 922 can be adjusted by the one or more controllers 702. In various embodiments, the winding speed can be set by a remote control 790. However, the present disclosure is not limited in this regard. For example, the one or more controllers 702 can be configured to adjust a winding speed based on various parameters of an irrigation line (e.g., an irrigation line diameter, a type of irrigation line, or the like). The present disclosure is not limited in this regard.

In various embodiments, the second end of the irrigation line 320 can be coupled to a second UAV (e.g., as shown in FIG. 5A). In various embodiments, a first portion of the irrigation line 320 can be coupled to a second UAV, and a second portion of the irrigation line 320 can be coupled to a third UAV. The present disclosure is not limited in this regard, and any number of UAVs for carrying an irrigation line 320 for installation on a heap 110 from FIG. 1 is within the scope of this disclosure.

In various embodiments, the process 1100 further comprises transporting, by the one or more controllers 702 and through the propulsion system 610, the irrigation line to the heap 110 as shown in FIGS. 3A-5B (step 1104). With combined reference now to FIGS. 3A-5B and 6-10 and in accordance with various embodiments, the one or more controllers 702 can navigate the UAV 600 to the heap 110 from the staging area of FIGS. 3A and 4A, via the positioning and navigation system 730. For example, the GPS 732 can provide an estimated current location of the UAV 600 relative to the heap 110. Based on the estimated current location, and a pre-programmed location of the heap (or based on a user controlling a direction of the UAV through the remote control 790), the one or more controllers 702 can navigate the UAV 600 to the heap 110. In various embodiments, while navigating the UAV 600 to the heap 110, the light detection and ranging (“LiDAR”) system 734 can provide real-time data to the one or more controllers 702 regarding surroundings of the UAV 600. In this regard, based on data received from the LiDAR system 734, the one or more controllers 702 can avoid obstacles, determine an estimated distance from the heap 110, modify a respective flight path, or the like.

In various embodiments, the process 1100 further comprises identifying and locating, by the one or more controllers 702 and based on the positioning and navigation system (e.g., the global positioning system (GPS) 732, the LiDAR system 734, and/or the one or more sensors 736), a placement location for the irrigation line (step 1106). In various embodiments, the identifying and locating in step 1106 can be based on a layout stored in a memory of the one or more controllers 702, based on a relative position to an adjacent irrigation line, a combination of a layout and a relative distance, or the like. The present disclosure is not limited in this regard. In various embodiments, an initial location of a first irrigation line can be set (e.g., via a layout or the like), and subsequent locations for irrigation lines can be relative to the first irrigation line (or adjacent irrigation lines). For example, the one or more controllers 702 can be configured to space apart a second irrigation line a set distance from a first irrigation line (e.g., between 1 foot (0.3 meters) and 3 feet (0.9 meters), or approximately 2 feet (0.6 meters)) and substantially parallel to the first irrigation line (e.g., between −15° and 15°, or approximately) 0°, or the like. In this regard, the one or more controllers 702 can be configured to receive position data (e.g., from the one or more sensors 736), while positioning the irrigation line 320 as described further herein and adjust the positioning based on pre-set parameters, in accordance with various embodiments.

In various embodiments, the process 1100 further comprises placing, by the one or more controllers 702 and through the positioning and navigation system (e.g., the global positioning system (GPS) 732, the LiDAR system 734, and/or any other sensors 736), the irrigation line 320 on the heap (e.g., heap 110 from FIG. 1) (step 1108). In various embodiments, the one or more controllers 702 are configured to place the irrigation line on a sloped surface 112 of the heap 110 from FIG. 1. However, the present disclosure is not limited in this regard, and placement of the irrigation line on a top surface 114 of the heap 110 from FIG. 1 is within the scope of this disclosure.

In various embodiments, the process 1100 further comprises avoiding (e.g., during the transporting step 1104 or the placing step 1108), by the one or more controllers 702 and based on data received from the light detection and ranging (“LiDAR”) system 734 and/or one or more sensors 736, obstacles. For example, the system may have to avoid large boulders (depending on how high the drone(s) fly) or equipment at the top or bottom of the slope, personnel at the top, bottom, or middle of the slope (should anyone happen to be in the middle of a slope while the drone is flying), or the like.

In various embodiments, placing the irrigation line 320 on the heap 110 comprises unwinding, by the one or more controllers 702 and through the winch 922, the irrigation line from the drum 921. In this regard, the irrigation line 320 can be guided by the placing device 924 of the UAV 900 performing the unwinding (or via a second UAV as shown in FIG. 5B). In various embodiments, the one or more controllers 702 can receive real-time feedback (e.g., via the one or more sensors 736) during the unwinding process, and adjust a placement of the irrigation line 320 based on the sensor data. For example, in response to an irrigation line 320 placement falling outside of a threshold parameter (e.g., between 1 foot (0.3 meters) and 3 feet (0.9 meters)) from an adjacent irrigation line, the one or more controllers 702 can reposition the UAV 600, 900 until the irrigation line 320 being placed falls within the threshold parameter.

In various embodiments, the one or more controllers 702 are configured to monitor, based on data received from the one or more sensors, alignment and tension of the irrigation line 320 during the placing of the irrigation line. For example, the one or more sensors 736 can include a position sensor (e.g., coupled to the placement mechanism 650 or the like), an angle sensor, a tension sensor, or the like. In this regard, based on data received from the one or more sensors 736, the one or more controllers 702 can adjust an unwinding speed, a position of the UAV 600, or the like to maintain accurate placement of the irrigation line within threshold parameters as described previously herein.

In various embodiments, an unwinding speed of the winch 922 can be adjustable by the one or more controllers 702. In various embodiments, the unwinding speed can be set by the remote control 790. However, the present disclosure is not limited in this regard. For example, the one or more controllers 702 can be configured to adjust an unwinding speed based on real-time feedback from the one or more sensors 736 during placement of the irrigation line. For example, if the one or more controllers 702 determine that maintaining the irrigation line within threshold parameters is difficult, the one or more controllers 702 can be configured to slow down an unwinding speed and monitor the respective parameters more closely during the placing step 1108, in accordance with various movements. In various embodiments, the one or more controllers 702 can adjust unwinding speeds based on parameters of an irrigation line (e.g., an irrigation line diameter, a type of irrigation line, or the like). The present disclosure is not limited in this regard. For example, heavier and larger irrigation lines can be unwound more slowly relative to smaller and lighter irrigation lines, in accordance with various embodiments.

In various embodiments, the process 1100 further comprises releasing, by the one or more controllers 702 and through one of the handling assembly 630 and/or the placement mechanism 650, the irrigation line 320 on the heap 110 (step 1110). In this regard, the handling assembly 630 and/or the placement mechanism 650 can comprise a releasing mechanism configured to release the first end of the irrigation line that was secured in step 1102 of the process 1100 as described previously herein. In various embodiments, the one or more controllers 702 are configured to release the release mechanism after determining the first end of the irrigation line 320 is within the threshold parameters of a respective location to be released (e.g., within 1 foot (0.3 meters) and 3 feet (0.9 meters)) from an adjacent irrigation line, within a pre-set radius of a desired attachment location for the irrigation line to the irrigation system, or any other respective location that may be readily apparent to one skilled in the art.

In various embodiments, if the one or more controllers 702 determine that the irrigation line 320 is outside of a threshold parameter after the irrigation line has been released (e.g., in accordance with step 1110), the one or more controllers 702 can be configured to navigate the UAV 600 to the area that is outside the threshold parameter, secure the local portion of the irrigation line 320 to the UAV (e.g., via the placement mechanism 650), move the local portion within the threshold parameter, and release the local portion of the irrigation line 320. In this regard, manipulation of the placement of an irrigation line can occur after the irrigation line has been placed and still fall within the scope of this disclosure.

In various embodiments, the one or more controllers 702 can be responsive to instructions received from the remote control 790, instructions received from another UAV, or from a network. The present disclosure is not limited in this regard. For example, the process 1100 can further comprise receiving, by the one or more controllers 702 and through a receiver 742 of a communications module 740, a command signal, and controlling, by the one or more controllers 702, one of the handling assembly 630, the placement mechanism 650, and/or the propulsion system 610 based on the command signal.

Benefits, other advantages, and solutions to problems have been described herein regarding specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote various parts but not necessarily to denote the same or dissimilar materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, any of the above-described concepts can be used alone or in combination with any or all the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible considering the above teaching.

We claim:

1. A method for installing irrigation lines on a heap of a heap leach pad, the method comprising:
lifting, via one or more unmanned aerial vehicles (UAVs), an irrigation line;
transporting, via the one or more UAVs, the irrigation line to the heap; and
positioning, via the one or more UAVs, the irrigation line on the heap.

2. The method of claim 1, wherein the positioning of the irrigation line includes releasing the irrigation line on a sloped surface of the heap.

3. The method of claim 1, wherein the transporting the irrigation line includes transporting a first end of the irrigation line from a staging area to a top surface of the heap.

4. The method of claim 3, wherein the positioning the irrigation line includes releasing the first end of the irrigation line from the one or more UAVs onto the top surface of the heap.

5. The method of claim 4, further comprising coupling the first end of the irrigation line to an irrigation system.

6. The method of claim 5, further comprising:
decoupling a second end of the irrigation line from an apparatus on a ground surface, and
coupling the second end to the irrigation system, wherein the irrigation line is oriented along a sloped surface of the heap and extending from the first end to the second end along the sloped surface of the heap.

7. The method of claim 1, further comprising unwinding the irrigation line from a spool during the transporting the irrigation line.

8. The method of claim 7, wherein the spool is disposed on a ground surface proximate the heap.

9. The method of claim 1, wherein a first end of the irrigation line is supported by a harness during the transporting the irrigation line.

10. The method of claim 9, wherein the positioning the irrigation line further comprises releasing the harness onto a top surface of the heap.

11. The method of claim 10, further comprising:
decoupling the first end of the irrigation line from the harness after the releasing the harness onto the top surface of the heap, and
coupling the first end of the irrigation line to an irrigation system.

12. The method of claim 11, wherein the lifting the irrigation line further comprises lifting a plurality of irrigation lines via the harness, and wherein the method further comprises:
decoupling the first end of each of the plurality of irrigation lines from the harness after the releasing the harness onto the top surface, and
coupling the first end of each of the plurality of irrigation lines to the irrigation system.

13. The method of claim 1, wherein the lifting the irrigation line further comprises lifting a plurality of irrigation lines via a harness, the plurality of irrigation lines including the irrigation line.

14. The method of claim 13, further comprising releasing a first end of each of the plurality of irrigation lines from the harness sequentially.

15. The method of claim 13, further comprising releasing a first end of each of the plurality of irrigation lines from the harness simultaneously.

16. The method of claim 1, further comprising:
releasing a first end of the irrigation line from one of the one or more UAVs;
decoupling a second end of the irrigation line from one of a second of the one or more UAVs or an apparatus disposed on a ground surface;
coupling the first end of the irrigation line to an irrigation system of the heap leach pad; and
coupling the second end of the irrigation line to the irrigation system of the heap leach pad.

17. The method of claim 16, wherein responsive to the coupling the first end and the second end of the irrigation line to the irrigation system, the irrigation line extends from a top surface of the heap leach pad, down a sloped surface of the heap leach pad, to one of the ground surface or an intermediate level down the slope.

18. The method of claim 1, wherein the positioning of the irrigation line includes adjusting, via the one or more UAVs, a position of the irrigation line on the heap based on sensor data received from one or more sensors of the one or more UAVs.

19. The method of claim 1, wherein the positioning further comprises unwinding, via the one or more UAVs, the irrigation line on the heap.

20. An unmanned aerial vehicle (“UAV”) configured for precise placement of irrigation lines on a heap, the UAV comprising:
a UAV body;
a propulsion system coupled to the UAV body;
an irrigation line support structure coupled to the UAV body, the irrigation line support structure configured to couple one or more irrigation lines to the UAV body;
a placement mechanism configured to release one of the irrigation line support structure or the one or more irrigation lines; and
one or more controllers in operable communication with the propulsion system and the placement mechanism, the one or more controllers configured to:
transport, via the propulsion system, the one or more irrigation lines to the heap;
place, via a positioning and navigation system, the one or more irrigation lines on the heap; and
release, via the placement mechanism, one of the irrigation line support structure or the one or more irrigation lines on the heap.
